(19) United States
(12) Patent Application Publication
(10) Pub. No.: US 2026/0050198 A1
(43) Pub. Date: Feb. 19, 2026

(54) PHOTONIC NETWORK

(71) Applicant: COGNIFIBER LTD., Rosh Ha’Ayin (IL)

(72) Inventors: Eyal COHEN, Gedera (IL); Zeev ZALEVSKY, Rosh Ha'Ayin (IL); Maya YEVNIN, Tel Aviv (IL)

(21) Appl. No.: 18/865,818

(22) PCT Filed: Jun. 12, 2023
(86) PCT No.: PCT/IL2023/050600

§ 371 Date: Nov. 14, 2024

Related U.S. Application Data
(60) Provisional application No. 63/351,609, filed on Jun. 13, 2022.

(51) Int. Cl. G02F 1/31

(52) U.S. Cl. CPC G02F 1/311

(57) ABSTRACT

A photonic system includes a photonic mesh comprising a first array of N input light guiding units located in a first plane and arranged in a spaced-apart substantially parallel relationship along a first axis, and a second array of M output light guiding units located in a second plane and arranged in a spaced-apart substantially parallel relationship along a second axis intersecting with the first axis. The optical coupler is configured for coupling a portion of an input light signal from the input light guiding unit into the output light guiding unit at the respective node, and is configured as a tunable modulation structure controllably switchable between various operative states by a tuning field, configured as a weighting signal to effect a corresponding intensity modulation of the portion of the light signal being coupled from the input light guiding unit into the output light guiding unit by said optical coupler.

### TECHNOLOGICAL FIELD AND BACKGROUND

The technique of the present disclosure relates to a photonic network, which is particularly useful in photonic artificial intelligence neural network applications.

In general-purpose processor offering high computational flexibility, matrix operations take place serially, one-at-a-time, while requiring continuous access to the cache memory, and consequently generating the so called “von Neumann bottleneck”. Various architectures for neural networks (NN) such as Graphic Process Units (GPUs) and Tensor Process Units (TPUs), have been engineered to reduce the effect of the von Neumann bottleneck enabling cutting-edge machine learning models. The paradigm of these architectures is to offer domain-specificity such as being optimized for performing convolutions or Matrix Vector Multiplications (MVMs) operations, unlike CPUs, in parallel deploying for instance via systolic algorithms

In recent years, the revolutionizing impact of machine learning (ML) and specifically, neural network (NNs) motivated the development of a various emerging photonic technologies, ranging from free-space diffractive optics to nanophotonic processors aiming to improve the computational efficiency of specific tasks performed by ML/NN. Integrated photonic platforms can indeed provide parallel, power-efficient computing, which is possible because photonic chips can perform the dot product inherently using light-matter interactions such as via a phase shifter, and enable signal accumulation (summation) by either electromagnetic coherent interference or incoherent accumulation through detectors, as well as enable parallelism strategies and higher throughput using multiplexing schemes such as wavelength- or polarization division multiplexing, for example.

For example, the article “Parallel convolutional processing using an integrated photonic tensor core”, J. Feldmann et al., Nature, vol. 589, 7 Jan. 2021 describes a computationally specific integrated photonic hardware accelerator (tensor core). The tensor core can be considered as the optical analogue of an application-specific integrated circuit (ASIC). It provides parallelized photonic in-memory computing using phase-change-material memory arrays and photonic chip-based optical frequency combs (soliton microcombs).

### GENERAL DESCRIPTION

There is a need in the art for a novel photonic processing device capable of performing parallelized computation tasks/operations (e.g., matrix-vector multiplications (MVM)) at optical data rates enabling high computational throughput and low latency in a single physical processing unit. Some examples of the computation tasks that can be performed by the photonic processing device include convolution, matrix multiplication, Fourier transform, etc.

Considering the above-described technique of J. Feldmann et al., it should be noted that speed of signal modulation implemented by phase-change materials (PCMs) is associated with the transition phase of the material in response to a change of its temperature, which is thus not sufficiently high. Consequently, when implemented in a photonic processor (e.g., for attenuation of light), these PCMs may significantly slow down the overall computation time of the processor.

The present disclosure provides a novel photonic processor device which includes a network (e.g. mesh) of fully connected light guiding units (e.g., waveguides or optical fibers) in which full and flexible connectivity is achieved by integrating a controllable optical coupler to each photonic intersection (node) between the light guiding units. The controllable optical coupler includes a light guiding element for optically coupling a portion of light from one light guiding unit to the other intersecting light guiding unit, and is configured as a tunable modulation structure, being either electrically or optically tunable.

Each controllable optical coupler is independently controllably operated by application of a control electrical field (voltage) or optical field (light) to vary the operational state of the coupler from its passive state into its active state and between its various different active states, while the coupler, in any of its active state, applies intensity modulation to light passing therethrough. In this connection, it should be understood that variation of the operational state of the coupler may be continuous, using analog voltage values.

The controllable optical couplers configured according to the technique of the present disclosure, as described above, are at times referred to herein below as “couplers”, “optical couplers”, “controllers”or “control units”.

Integration of the above-described electrically or optically tunable modulation functionality in the optical coupler can be implemented by either configuring the light guiding element of the coupler as the electrically or optically tunable modulation structure, or by integrating an electrically or optically tunable modulator within the light guiding element of the coupler.

The couplers (electrically or optically tunable modulation structures) are configured with variable optical properties in response to applied electrical or light field, i.e., the coupler is responsive to the applied field by a change in its optical property(ies), such as absorption/transmission property and/or refractive index and/or amplification properties, thus directly affecting the intensity of light passing therethrough or via a change in a phase of a component of the light passing therethrough.

Such a change in the optical properties in response to applied electrical or light field can be implemented relatively fast, and provides modulation of optical signals passing through the coupler. Accordingly, application of time-varying modulations of optical signal (via switching between various different modulations/active states of the coupler) can be carried out at sufficiently high speeds.

The photonic mesh of the present disclosure includes a first array of input light guiding units arranged in a first plane in a spaced-apart substantially parallel relationship along a first axis, and a second array of output light guiding units arranged in a second plane in a spaced-apart substantially parallel relationship along a second axis intersecting with the first axis (e.g., second axis is substantially perpendicular to the first axis). This configuration forms a matrix of aligned regions of the input light guiding units and output light guiding units presenting network nodes.

It should be understood that the first and second planes may be substantially coinciding, or may be spaced-apart from one another, provided proper coupling between the light guiding units at the nodes is included.

Also provided in the photonic mesh is a matrix of optical couplers accommodated at the network nodes, respectively, each optical coupler being configured and operable to provide optical coupling of light form the input light guiding units to the output light guiding unit at the respective node (i.e., at the aligned regions of the input and output light guiding units, effecting “intersection” between these units). Each of the optical couplers is also configured as electrically or optically tunable modulation structure.

Thus, each input light guiding unit can be optically coupled to each of the output light guiding units at the network nodes'regions via respective couplers, such that the coupler redirects (“drops”) a portion (depending on a degree of coupling) of the input light signal propagating in the input light guiding unit into the intersecting output light guiding unit, while allowing the remaining portion of the input light signal to continue its propagation in the input light guiding unit towards the successive node where the respective coupler performs such redirection into the respective output light guiding unit.

As indicated above, the optical couplers are configured as the electrically or optically tunable modulation structures, each being independently controllably switchable by application of a tuning field (being an electric field (voltage) or light field) between its various operative states. The coupler, in its active state, affects intensity modulation of the light portion being dropped (coupled) into the output light guiding unit. The applied tuning field is selected (controlled) in accordance with a predetermined weighting to be applied to the light portion to be coupled/dropped to the output light guiding unit. Thus, all the couplers are connected to a control system which includes weighting signal controllers.

It should be noted that the optical properties of the input light signals provide substantial non-interference between them. This can be achieved by using substantially incoherent light signals or light signals of different wavelengths. To this end, a light input device associated with input ports of the input light guiding units can include a wavelength division multiplexer.

The light guiding units can be fabricated by using various techniques which include, inter alia, 3D femto-laser scribing, 3D printing, or silicon photonics techniques.

In some embodiments, the tunable modulation structure of the coupler can be implemented by integrating a tunable modulator within the light guiding element of the coupler. Such tunable modulator may be an electroabsorption modulator (EAM), or a semiconductor optical amplifier (SOA), or a liquid crystal modulator. The tunable modulator is accommodated within the light guiding element of the coupler in an optical path of the light portion being dropped from the input light guiding unit by said coupler and propagating towards the respective output light guiding unit.

As indicated above, in some other embodiments, the tunable modulation structure of the coupler is implemented by configuring the light guiding element of the coupler as the tunable modulator. This can for example be implemented by making a core of the light guiding element of the coupler from electro-absorbing material (typically, semiconducting material composition), e.g., Si or Ge—Si, InGaAlAs or InP. In such embodiments, the light guiding units and the couplers (light guiding elements) can be fabricated using similar CMOS-compatible techniques.

In yet further embodiments, the light guiding element of the coupler is configured as or includes an electro-optical modulator, such as a Mach-Zehnder interferometer incorporating a phase shifting unit, such as one made of LiNbO3.

Thus, according to a broad aspect of the invention, it provides a photonic system comprising:
a photonic mesh comprising a first array of N input light guiding units located in a first plane and arranged in a spaced-apart substantially parallel relationship along a first axis, and a second array of M output light guiding units located in a second plane and arranged in a spaced-apart substantially parallel relationship along a second axis intersecting with the first axis, therefore defining an N×M matrix of nodes; and
the N×M matrix of optical couplers accommodated at said nodes, respectively,
wherein each of said optical couplers is configured for optically coupling a portion of a light signal from the input light guiding unit into the output light guiding unit at the respective node, and each of said optical couplers is configured as a tunable modulation structure being controllably switchable between various operative states by application of a tuning field being an electrical or light field configured as a weighting signal to effect a corresponding intensity modulation of the portion of the light signal being coupled from the input light guiding unit into the output light guiding unit by said optical coupler.

The number N of the input light guiding units may be the same or different from number M of the output light guiding units.

The optical coupler comprises a light guiding element located at the node and configured for coupling the portion of a light signal propagated by the input light guiding unit into the output light guiding unit passing through said node and allowing a remaining portion of the input light signal to propagate through said input light unit towards a successive node.

In some embodiments, the optical coupler is comprised of the light guiding element configured as the electrically tunable modulator/modulation structure, which is responsive to the exciting/tuning field by a change of optical properties of the light guiding element which change, in turn, causes an intensity modulation of the light signal passing through the coupler in correspondence with said exciting electric field.

For example, such light guiding element configured as the tunable modulation structure/modulator may comprise an Er-doped glass receiving electrically controlled pump light with varying intensity.

In some examples, a core of the light guiding element is configured from an electro-absorbing material composition, typically a semiconducting material composition, e.g., Si, Si—Ge, InGaAlAs or InP.

In some other embodiments, the optical coupler comprises the light guiding element containing therein a tunable modulator. Such tunable modulator is configured to be switchable by the exciting/tuning field (electric field or light field) between various operative states characterized by various optical properties of the modulator such that light signal interaction with the modulator causes an intensity modulation of the light signal in correspondence with said exciting electric field.

The tunable modulator inside the light guiding element of the coupler may be configured including any one of the following: electroabsorption modulator, semiconductor optical amplifier, liquid crystal modulator, Mach-Zehnder interferometer. In the latter case, at least one arm of the interferometer has a region containing a tunable modulator (e.g. LiNbO₃ unit), which when being applied to the exciting/tuning field affects a phase change to light component passing therethrough thereby affecting a phase difference between light components passing through the arms of the interferometer resulting in an intensity modulation of light being output from the interferometer.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a schematic illustration of a fully connected photonic mesh of the present disclosure;

FIGS. 2A and 2B exemplify two configurations, respectively, of the coupler suitable to be used in the fully connected photonic mesh of FIG. 1;

FIG. 2C exemplifies the electro-absorbing coupler implemented as or including a Mach-Zehnder type modulator; and

FIGS. 3A-3C schematically illustrate an example of the photonic mesh configuration utilizing the arrays of input and output light guiding units located in spaced-apart planes, respectively, wherein FIGS. 3A and 3B show perspective and side views, respectively, of the photonic mesh and FIG. 3C shows the coupler used at the node of the mesh of this configuration.

### DETAILED DESCRIPTION OF EMBODIMENTS

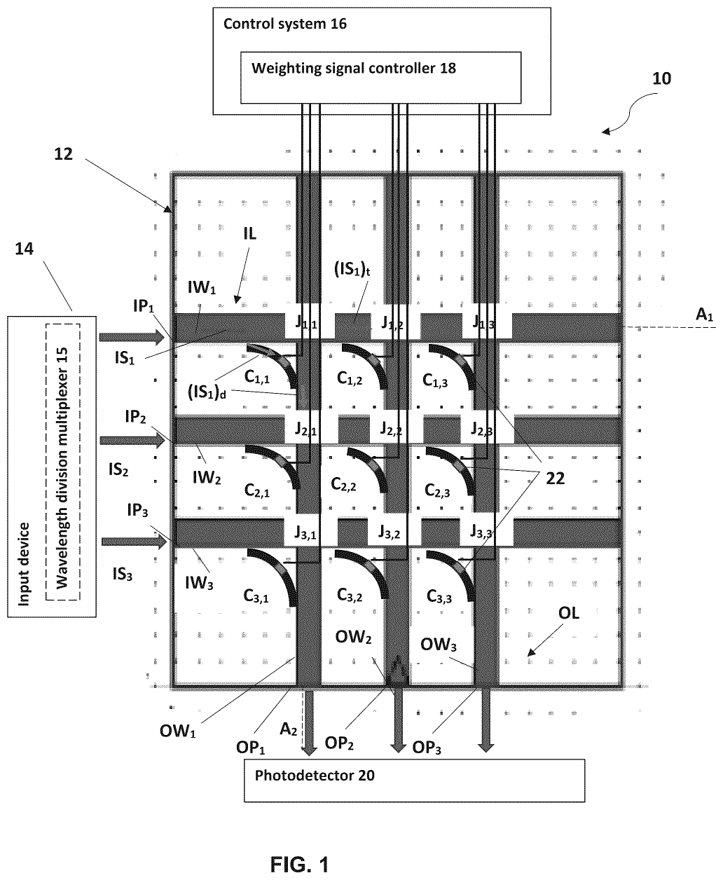

Reference is made to FIG. 1 schematically illustrating a photonic system 10 of the present disclosure. The photonic system 10 includes a fully connected photonic mesh/network 12 associated with a control system 16. The photonic mesh 12 is interconnected between a light input device 14 and a light output device (photodetector system) 20.

The photonic mesh 10 includes an input array IL of N (N≥2) spaced-apart substantially parallel input light guiding units IW₁ . . . IWₙ (waveguides or optical fibers) extending along a first axis A₁, and an output array OL of M (M≥2) spaced-apart substantially parallel output light guiding units OW₁ . . . OWₘ extending along a second axis A₂ intersecting with that of the input light guiding units. The number M of the output light guiding units OW₁ . . . OWₘ may or may not be equal to the number N of the input light guiding units IW₁ . . . IWₙ. For example, the input light guiding units may be substantially perpendicular to the output light guiding units. The input light guiding units IW₁ . . . IWₙ by their input ports IP₁ . . . IPₙ are connected to the input device 14, and the output light guiding units OW₁ . . . OWₘ by their output ports OP₁ . . . OPₘ are connected to the photodetector system 20.

In the exemplary system 10 illustrated in the figure, three input light guiding units IW₁, IW₂, and IW₃ and three output light guiding units OW₁, OW₂, and OW₃ are shown. The input light guiding units IW₁, IW₂, IW₃ by their input ports IP₁, IP₂, IP₃ are connected to the input device 14, and the output light guiding units OW₁, OW₂, OW₃ by their output ports OP₁, OP₂, OP₃ are connected to the photodetector system 20.

The input light guiding units and the output light guiding units are located in first and second planes which may be substantially coinciding or may be spaced-apart from one another, such that regions of intersections between the input and output light guiding units (in case of substantially coinciding first and second planes) or regions of input light guiding units aligned with the regions of output light guiding units (in case of spaced-apart first and second planes) form an N×M array of nodes/junctions J_{n,m} of the mesh/network. In the figure, nodes J₁₁, J₁₂, J₁₃, J₂₁, J₂₂, J₂₃, J₃₁, J₃₂ and J₃₃ are shown.

Each ij-th node is associated with its respective optical coupler Cij—couplers C₁₁, C₁₂, C₁₃, C₂₁, C₂₂, C₂₃, C₃₁, C₃₂ and C₃₃ being shown in the figure associated with respective nodes J₁₁, J₁₂, J₁₃, J₂₁, J₂₂, J₂₃, J₃₁, J₃₂ and J_{33.} Thus, each i-th input light guiding unit IWᵢ from N input light guiding units is optically coupled with each of the M output light guiding units OW₁ . . . OWₘ via respective optical couplers Cᵢ₁ . . . Cᵢₘ at the nodes.

Each optical coupler C_{i,j} (i=1, . . . , N; j=1, . . . M) is configured as a tunable modulation structure capable of optical coupling between the i-th input light guiding unit and j-th output light guiding unit at the respective node where the coupler Cᵢⱼ is located and for selectively applying intensity modulation to light passing therethrough.

The operation of each coupler is exemplified in the figure with respect to coupler C₁₁. As shown, the coupler drops/couples a portion (IS₁)_{d} of an input light signal IS₁ propagating in the input light guiding unit IW₁ into the output light guiding unit OW₁ at the node J₁₁ allowing the remaining portion (IS₁)ₜ of the signal IS₁ to propagate through the input light guiding unit IS₁ towards the successive node J₁₂ to undergo a successive coupling of a portion of this light into a successive output light guiding unit OW₂ by the coupler C₁₂ at the successive node J₁₂ and possible also undergo intensity modulation by the electrically or optically tunable modulation functionality of the coupler C₁₂ (depending on the controllable switching of the coupler between its different operational states characterized by different modulation functions).

The light portion (IS₁)_{d} being dropped by the coupler can undergo intensity modulation by the tunable modulation structure of said coupler. The dropped light portion (IS₁)_{d} (e.g., with the intensity modulation) continues propagation along the respective output light guiding unit OW₁ towards the respective output port OP₁.

It should be noted that the light signals being input into the mesh are substantially not-interfering signals. This can be achieved by utilizing light signals of different wavelengths, e.g., by using a wavelength division multiplexer 15 at the light input device 14; or by utilizing substantially incoherent input light signals.

The amount of light of the dropped/coupled portion is defined by a predetermined degree of coupling at the respective node. It should be noted that degrees of coupling may or may not be the same at different nodes. Generally, the degree of coupling depends mainly on the materials used in the coupler and a distance between the light guiding units (waveguides) and the light guiding element of the respective coupler.

The tunable modulation structures (couplers) are connected to the control system 16. The latter includes a controllably operated tuning field source (e.g. voltage supply system or light source system) which functions as a weighting signal controller 18. The coupler can be switchable from its passive state/condition, in which the optical property of the coupler remains unchanged and it thus does not affect light passing therethrough, into its selective active state/condition by application of the tuning field causing a change in the optical property of the modulation structure of the coupler or within the coupler (as described above). Similarly, the coupler can be switched between its various different active states characterized by different optical properties, differently affecting light passing therethrough. The coupler, while being in the active operative state, affects intensity modulation (attenuation/gain) of light interacting with such coupler (passing therethrough) in accordance with the weighting signal corresponding to the applied electric field.

Generally, the tunable modulation structure may be implemented as a light guiding element (e.g., waveguide or optical fiber) whose core is made of tunable material composition, or as a light guiding element (e.g., waveguide or optical fiber) including a tunable modulator located therein. As shown in the non-limiting example of FIG. 1, each coupler is a light guiding element including the tunable modulator, generally at 22.

The tunable modulator 22 can for example be configured as an electro-absorption modulator (EAM) in which an applied electric field yields change in the absorption spectrum via Franz-Keldysh effect in bulk semiconductors, or via the quantum-confined Stark effect (QCSE) in quantum wells. Electro-absorption modulators are generally known and therefore need not be specifically described, except to note the following: In the Franz-Keldysh effect, the electric field changes the bandgap energy due to change in overlap of wavefunctions of excitons (electron and hole) thereby affecting the optical absorption/transmission of the optical signals interacting with the electrically tunable modulator 20 (the more overlap the stronger the absorption). In the quantum-confined Stark effect (QCSE), an applied field skews the potential well (quantum well), and this causes the hole and electron energy levels to shift, decreasing the gap between these levels, manifesting in change in the optical absorption.

Alternatively, the tunable modulator 20 can be an optical amplifier, e.g., semiconductor optical amplifier (SOA), in which electrons are excited in response to an applied tuning field. When photons travel through the active region it can cause these electrons to lose some of their extra energy in the form of more photons that match the wavelength of the initial ones. Therefore, an optical signal passing through the active region is amplified. SOAs are also generally known and therefore need not be specifically described.

In some embodiments the tunable modulation structure C or the tunable modulator 22 in the light guiding element of the coupler C can be implemented as electro optic modulator, e.g., Mach-Zehnder modulator (MZM) in which at least one of the arms is made of material with strong electro-optic effect (such as LiNbO₃, InGaAs, InP). Application of electric fields to said at least one arm of the MZM affects a change of the optical path length within said arm thus affecting a phase modulation of light component passing through the respective arm of the MZM resulting in a phase difference between the light components propagating through the two arms. Combining light components with such phase difference between them provides the intensity modulation.

It should also be noted that other types of electrically or optically tunable modulators, such as a liquid crystal (LC) modulator, can also be used.

Each tunable modulation structure (e.g., the tunable modulator 22 inside the light guiding element of the coupler or the light guiding element configured as the modulator) is connected to the weighting controller 18 which selectively provides weighting signals (voltage or light) in accordance with the weighting to be applied to the light signal passing through the respective coupler.

The optical signals (including intensity modulated optical signals) exit the M output guiding units via the respective output ports and directed towards the photodetector system 20.

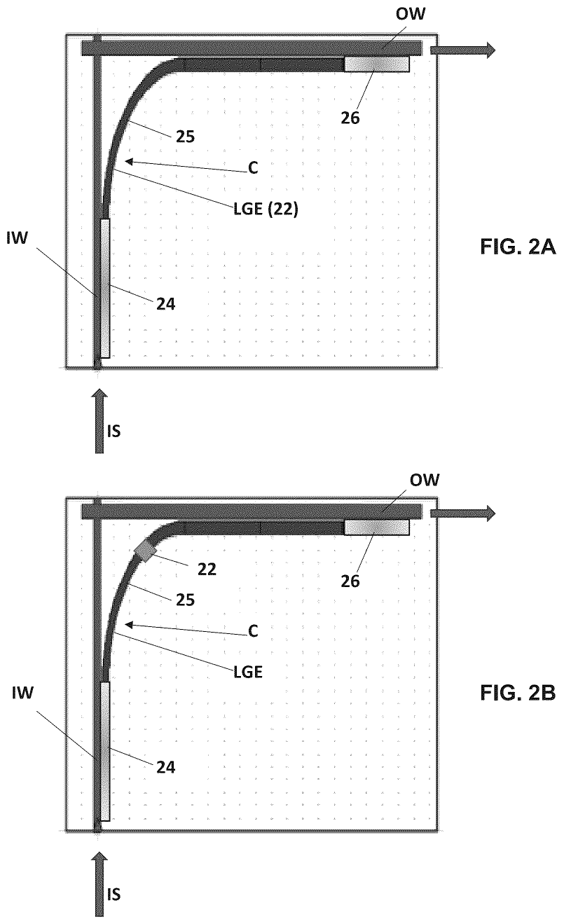

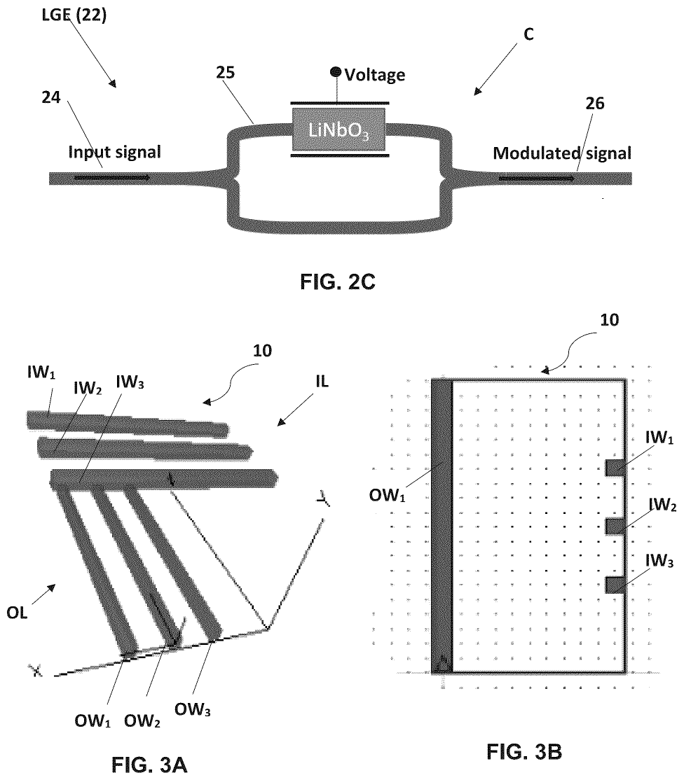

Reference is made to FIGS. 2A and 2B schematically illustrating exemplary configurations of the coupler C configured and operable as a tunable modulation structure. The coupler C includes a light guiding element LGE having a first coupling segment 24 defining a coupling region with the input light guiding unit IW and a second coupling section 26 defining a coupling region with the intersecting/aligned output light guiding unit OW, and intermediate segment 25 therebetween. The dimensions and material compositions of the coupling regions 24 and 26 are selected to provide desired degrees of coupling with the respective light guiding units. The first and second coupling regions 24 and 26 can have the same or different degrees of coupling.

It should be noted that the coupling regions can be formed of or include any light guiding material such as but not limited to any one or more of the following: silica, silicon, InGaAs, Ge etc., depending on the operational wavelength(s). The coupling coefficient depends is not material dependent. but rather depends on the structure of the coupler, e.g., its distance from the waveguide, its width, its NA, etc.

As indicated above, either the entire light guiding element of the coupler or at least a part thereof at the intermediate segment 25 is configured with tunable modulation functionality/property thus forming a tunable modulation structure of the coupler.

With reference to example of FIG. 2A, the intermediate segment 25 can be made of materials such as SiO₂ or SiN with electrodes accommodated within and along said segment 25 for applying an electric field in a direction perpendicular to the light signals propagating therethrough; or the entire light guiding element of the coupler C can be made of electrically tunable material such as Si or Ge—Si, InGaAlAs or InP.

Alternatively, as exemplified in FIG. 2B, the intermediate segment 25 includes the tunable modulator 22. As mentioned above, such a tunable modulator can be EAM or SOA.

As mentioned above, the light guiding element LGE of the coupler C may be configured as Mach-Zehnder type modulator or may include such Mach-Zehnder type modulator 22. This is exemplified in FIG. 2C in a self-explanatory manner. The Mach-Zehnder modulator may include a Lithium Niobate (LiNbO₃) coating/film within a portion/segment of one arm which, when excited by the applied tuning field, exhibits a change in a refractive index and therefore affects the phase of light signal passing through said segment. For example, the input and output sections of the Mach-Zehnder type modulator may present the input and output segments 24 and 26 of the coupler.

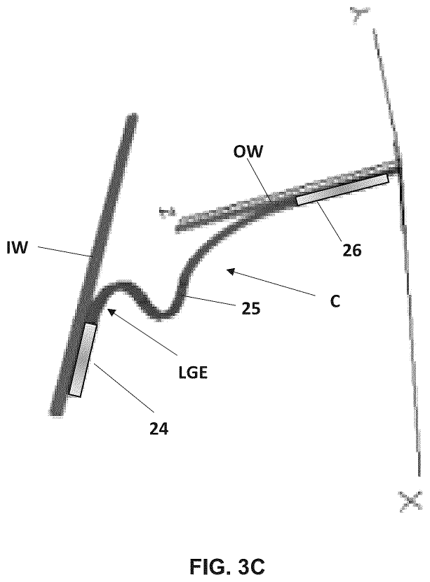

Reference is made to FIGS. 3A-3C schematically illustrating a three-dimensional configuration of the fully connected photonic mesh 12 of the present disclosure. FIGS. 3A and 3B show a perspective and side views, respectively, of the mesh 12, and FIG. 3C shows implementation of the light guiding element of the coupler C in the three-dimensional configuration.

As shown in FIGS. 3A and 3B, the input layer IL (plane of location of input light guiding units) and the output layer OL (plane of location of output light guiding units) are spaced-apart parallel layers. As exemplified in the figures. the input light guiding units IW₁, IW₂, and IW₃ of the input layer IL are located above or below the output light guiding units OW₁, IW₂, and OW₃ of the output layer OL. FIG. 3C shows the light guiding element LGE of the coupler C connecting between a certain input light guiding unit IW and a certain output light guiding unit OW.

1. A photonic system comprising:
a photonic mesh comprising a first array of N input light guiding units located in a first plane and arranged in a spaced-apart substantially parallel relationship along a first axis, and a second array of M output light guiding units located in a second plane and arranged in a spaced-apart substantially parallel relationship along a second axis intersecting with the first axis, therefore defining an N×M matrix of nodes; and
the N×M matrix of optical couplers accommodated at said nodes, respectively,
wherein each of said optical couplers is configured for coupling a portion of an input light signal from the input light guiding unit into the output light guiding unit at the respective node, and each of said optical couplers is configured as a tunable modulation structure being controllably switchable between various operative states by application of a tuning field, being an electric field or a light field, configured as a weighting signal to effect a corresponding intensity modulation of the portion of the light signal being coupled from the input light guiding unit into the output light guiding unit by said optical coupler.

2. The photonic system according to claim 1, wherein the optical coupler comprises a light guiding element located at the node and configured for coupling the portion of the light signal propagated by the input light guiding unit into the output light guiding unit passing through said node and allowing a remaining portion of the input light signal to propagate through said input light unit towards a successive node.

3. The photonic system according to claim 2, wherein the light guiding element of the optical coupler is configured as the tunable modulation structure which is responsive to the tuning field to be switchable between its different operative states characterized by different optical properties of the tunable modulation structure differently affecting intensity modulation of the light signal passing through the light guiding element in correspondence with the applied tuning field.

4. The photonic system according to claim 3, wherein a core of the light guiding element is configured from an electro-absorbing material composition.

5. The photonic system according to claim 3, wherein the core of the light guiding element is configured from a semiconducting material composition.

6. The photonic system according to claim 4, wherein the core of the light guiding element is configured from a semiconducting material composition.

7. The photonic system according to claim 5, wherein the core of the light guiding element is configured from at least one of Si, Si—Ge, InGaAlAs, InP.

8. The photonic system according to claim 6, wherein the core of the light guiding element is configured from at least one of Si, Si—Ge, InGaAlAs, InP.

9. The photonic system according to claim 2, wherein the optical coupler comprises an Er-doped glass.

10. The photonic system according to claim 2, wherein the light guiding element of the coupler contains therein a tunable modulator, said tunable modulator being configured to be switchable by the tuning field between its various operational states characterized by different optical properties of the modulator differently affecting an intensity modulation of the light signal passing through the light guiding element in correspondence with said electric field.

11. The photonic system according to claim 10, wherein the tunable modulator is configured as an electro-absorption modulator.

12. The photonic system according to claim 10, wherein the tunable modulator is configured as a semiconductor optical amplifier.

13. The photonic system according to claim 10, wherein the tunable modulator is configured as a liquid crystal modulator.

14. The photonic system according to claim 10, wherein the tunable modulator is configured as a Mach-Zehnder interferometer, at least one arm of the interferometer comprising a region containing a tunable unit, which when being applied to the tuning field affects a phase change of light component passing therethrough thereby affecting a phase difference between light components passing through the arms of the interferometer resulting in an intensity modulation of light being output from the interferometer.

15. The photonic system according to claim 14, wherein said tunable unit is configured as LiNbO₃ unit.

16. The photonic system according to claim 14, wherein said tunable unit is configured as a semiconductor optical amplifier (SOA).

17. An optical coupler for use in a node of an N×M matrix of nodes of a photonic system formed by an array of N input light guiding units in a first plane and an array of M output light guiding units in a second plane, the optical coupler being configured for coupling a portion of an input light signal from an input light guiding unit into an output light guiding unit at said node, the optical coupler being configured as a tunable modulation structure being controllably switchable between various operative states by application of a tuning field, being an electric field or a light field, configured as a weighting signal to effect a corresponding intensity modulation of a portion of a light signal being coupled from the input light guiding unit into the output light guiding unit.

18. The optical coupler according to claim 17, comprising a light guiding element located at the node and configured for coupling the portion of the light signal propagated by the input light guiding unit into the output light guiding unit passing through said node and allowing a remaining portion of the input light signal to propagate through said input light unit towards a successive node of the photonic system.

19. The optical coupler according to claim 18, wherein the light guiding element is configured as the tunable modulation structure which is responsive to the tuning field to be switchable between its different operative states characterized by different optical properties of the tunable modulation structure differently affecting intensity modulation of the light signal passing through the light guiding element in correspondence with the applied tuning field.

20. The optical coupler according to claim 19, wherein a core of the light guiding element is configured from an electro-absorbing material composition.

21. The optical coupler according to claim 19, wherein a core of the light guiding element is configured from a semiconducting material composition.

22. The optical coupler according to claim 20, wherein the core of the light guiding element is configured from a semiconducting material composition.

23. The optical coupler according to claim 21, wherein the core of the light guiding element is configured from at least one of Si, Si—Ge, InGaAlAs, InP.

24. The photonic system according to claim 6, wherein the core of the light guiding element is configured from at least one of Si, Si—Ge, InGaAlAs, InP.

25. The optical coupler according to claim 18, comprising an Er-doped glass.

26. The optical coupler according to claim 18, wherein the light guiding element contains therein a tunable modulator, said tunable modulator being configured to be switchable by the tuning field between its various operational states characterized by different optical properties of the modulator differently affecting an intensity modulation of the light signal passing through the light guiding element in correspondence with said electric field.

27. The optical coupler according to claim 26, wherein the tunable modulator is configured as an electro-absorption modulator.

28. The optical coupler according to claim 26, wherein the tunable modulator is configured as a semiconductor optical amplifier.

29. The optical coupler according to claim 26, wherein the tunable modulator is configured as a liquid crystal modulator.

30. The optical coupler according to claim 26, wherein the tunable modulator is configured as a Mach-Zehnder interferometer, at least one arm of the interferometer comprising a region containing a tunable unit, which when being applied to the tuning field affects a phase change of light component passing therethrough thereby affecting a phase difference between light components passing through the arms of the interferometer resulting in an intensity modulation of light being output from the interferometer.

31. The optical coupler according to claim 30, wherein said tunable unit is configured as LiNbO₃ unit.

32. The optical coupler according to claim 30, wherein said tunable unit is configured as a semiconductor optical amplifier (SOA).
